(19) United States
(12) Patent Application Publication
(10) Pub. No.: US 2013/0321977 A1
(43) Pub. Date: Dec. 5, 2013

(54) MULTILAYERED CERAMIC COMPONENT

(71) Applicant: Samsung Electro-Mechanics Co., Ltd., Suwon-si (KR)

(72) Inventors: Seung Ho LEE, Suwon-si (KR); Jong Han KIM, Suwon-si (KR); Eung Soo KIM, Suwon-si (KR)

(73) Assignee: SAMSUNG ELECTRO-MECHANICS CO., LTD., Suwon-si (KR)

(21) Appl. No.: 13/900,533

(22) Filed: May 23, 2013

(30) Foreign Application Priority Data
Jun. 4, 2012 (KR) 10-2012-0059916

(51) Int. Cl. H01G 4/008; H01G 4/30

(52) U.S. Cl. CPC H01G 4/008; H01G 4/30
USPC 361/301.4

(57) ABSTRACT

Disclosed herein is a multilayered ceramic component having a structure in which internal electrode layers and dielectric layers are alternately multilayered, wherein the internal electrode layer includes 0.01 to 12 wt % of common material based on weight of metal powders, and an average particle size of the common material is within 30% of an average particle size of the metal powders. According to the first exemplary embodiment of the present invention, the particle size and the added amount of common material squeezed out from the internal electrode layer at the time of firing at a high temperature are controlled, thereby making it possible to improve the connectivity of the internal electrode.

### CROSS REFERENCE(S) TO RELATED APPLICATIONS

This application claims the benefit under 35 U.S.C. Section 119 of Korean Patent Application Serial No. 10-2012-0059916, entitled “Multilayered Ceramic Component” filed on Jun. 4, 2012, which is hereby incorporated by reference in its entirety into this application.

### BACKGROUND OF THE INVENTION

1. Technical Field

The present invention relates to a multilayered ceramic component having excellent connectivity of an electrode.

2. Description of the Related Art

A multilayered ceramic capacitor (hereinafter, referred to as MLCC) is manufactured by forming an electrode layer by printing conductive paste on a formed dielectric layer sheet using screen, gravure, and the like, so as to print inner electrode layers and multilayering sheets on which the inner electrode layers are printed.

In the case of a super high capacity MLCC having small size, the dielectric layer and the internal electrode layer need to be thinned, and effective electrode area (internal electrode connectivity or coverage) influencing the capacity is important, in order to increase the number of layers.

The conductive paste is generally made of metal powder such as nickel (Ni), copper (Cu), or the like, an inorganic material of ceramic powder (a common material), or the like, and an organic material such as a dispersing agent, a resin, an additive, a solvent, or the like.

Since the metal powder such as Ni, Cu, or the like, generally used in an internal electrode paste has a melting point lower than that used in the dielectric layer, a temperature at which a sintering shrinkage starts is low. Therefore, the ceramic powder is added as a common material and is moved to a high temperature so that a shrinkage starting temperature thereof is similar to that of the dielectric layer as high as possible. Since the ceramic powder used as the common material at the process in which the internal electrode layers are fired is absorbed into the dielectric layer to finally influence dielectric characteristics, it is designed so as to have a composition which is the same as or similar to that of the dielectric layers. In a general case, barium titanate (BaTiO₃) having the same component as the dielectric layer is used as a main component of the common material. In order to highly increase a sintering starting temperature, various kinds of oxide-based minor components are used.

In addition, since the common material needs to be contributed between metal particles and to limit the sintering, particles having size smaller than that of the metal powder are used, and an added amount thereof is controlled according to a firing temperature of a MLCC chip.

In this case, in the case in which barium titanate having a predetermined particle size or smaller as compared to nickel is used, the common material may be not squeezed out and then remain in the center of the internal electrode according to the content thereof. The trapped common material controls the sintering shrinkage of the internal electrode in the range in which electrical characteristics of the electrode is not affected and contribute an improvement of electrode connectivity, thereby increasing the capacity of the MLCC chip.

In manufacturing the MLCC, the internal electrodes are sintered by the following processes.

The process includes (1) squeezing out the common material while shrinking the metal powders at 800 to 1000° C., (2) connecting the internal electrode layers with each other while shrinking the dielectric layers at 1000 to 1100° C., and (3) agglomerating the internal electrode layers while densifying the dielectric layers at 1100° C. or more.

As the sintering temperature is high, an electrode cut phenomenon increases in occurrence because the internal electrode layers are not connected to each other but cut, and since the fine metal powder is used for a thinned MLCC, the electrode cut phenomenon occurs more often.

Therefore, a multilayered ceramic component capable of improving the electrode connectivity by solving the electrode cut phenomenon of the internal electrode layers needs to be developed.

### RELATED ART DOCUMENT

### Patent Document

Patent Document 1 JP Patent Laid-Open Publication No. 2008-277066

### SUMMARY OF THE INVENTION

An object of the present invention is to provide a multilayered ceramic component capable of controlling content or size of a common material added to internal electrode layers, using high sintering driving force of the common material to increase connectivity of the internal electrode, and having various structures.

According to a first exemplary embodiment of the present invention, there is provided a multilayered ceramic component having a structure in which internal electrode layers and dielectric layers are alternately multilayered, wherein the internal electrode layer includes 0.01 to 12 wt % of common material based on weight of metal powders, and an average particle size of the common material is within 30% of an average particle size of the metal powders.

According to a second exemplary embodiment of the present invention, there is provided a multilayered ceramic component having a structure in which internal electrode layers and dielectric layers are alternately multilayered, wherein the internal electrode layer includes 0.01 to 12 wt % of common material based on weight of metal powders, an average particle size of the common material is within 30% of an average particle size of the metal powders, and a content ratio of the common material remaining in the internal electrode layer to the total common material content, after sintering, is 0.006˜0.1.

According to a third exemplary embodiment of the present invention, there is provided a multilayered ceramic component having a structure in which internal electrode layers and dielectric layers are alternately multilayered, wherein the internal electrode layer includes 0.01 to 12 wt % of common material based on weight of metal powders, an average particle size of the common material is within 30% of an average particle size of the metal powders, a content ratio of the common material remaining in the internal electrode layer to the total common material content, after sintering, is 0.006˜0.1, and when it is assumed that a fraction of the common material remaining in upper and lower regions in +20% from the center of the internal electrode layer is A(center) and the fraction of the common material remaining in a region of the internal electrode layer other than the region is A(interface), A(center)/A(interface) is 10 to 2.

The internal electrode layer may have a thickness of 0.1 to 0.5 μm.

The common material may include barium titanate (BaTiO₃) and a metal oxide.

The internal electrode layer may be made of nickel (Ni) or copper (Cu).

A metal of the metal oxide may be at least one lanthanide rare-earth element selected from a group consisting of Y³⁺, La³⁺, Ce³⁺, Pr³⁺, Nd³⁺, Sm³⁺, Eu³⁺, Gd³⁺, Tb³⁺, Dy₃₊, Ho³⁺, Er³⁺, Tm³⁺, Yb³⁺ and Lu³⁺.

### BRIEF DESCRIPTION OF THE DRAWINGS

FIG. 1 shows a partial structure of a cross section of a multilayered ceramic component according to a first exemplary embodiment of the present invention;

FIG. 2 shows a partial structure of a cross-section of a multilayered ceramic component according to a third exemplary embodiment of the present invention; and

FIG. 3 shows a partial structure of a cross section of a multilayered ceramic component according to the first exemplary embodiment of the present invention.

### DESCRIPTION OF THE PREFERRED EMBODIMENTS

Hereinafter, preferred embodiments of the present invention will be described in detail with reference to the accompanying drawings.

Terms used in the present specification are for explaining the embodiments rather than limiting the present invention. Unless explicitly described to the contrary, a singular form includes a plural form in the present specification. Also, used herein, the word “comprise” and/or “comprising” will be understood to imply the inclusion of stated constituents, steps, numerals, operations and/or elements but not the exclusion of any other constituents, steps, operations and/or elements.

The present invention provides a multilayered ceramic component having excellent electrode connectivity of an internal electrode layer and having high reliability.

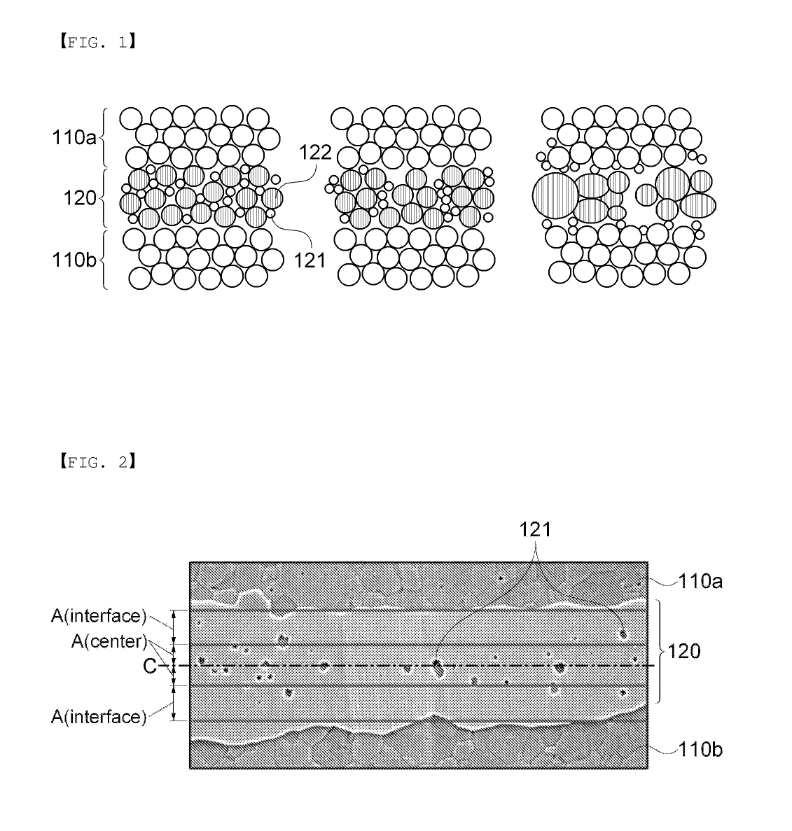

FIG. 1 shows a role of a general common material in manufacturing a m Referring to FIG. 1, in the case in which a dielectric sheet having an internal electrode layer 120 formed between dielectric layers 110a and 110b is sintered, common materials 121 included in the internal electrode layer 120 inhibit contraction starting of nickel metals 122 used as metal powders of the internal electrode layer 120 to thereby perform the role of the common material.

(2) Then, necking of the metal nickel powders 122 starts while the shrinkage of the metal nickel powders 122 starts at 700 to 900° C., such that the metal nickel powders 122 as well as the common materials 121 are agglomerated.

(3) Lastly, the common materials 121 are squeezed out from the internal electrode layer 120 at 900 or higher, and thus move, and absorb into the dielectric layers 110a and 110b or a separate common material accumulated layer is formed. The dielectric layers 110a and 110b starts to be sintered and reacts to the common material introduced from the internal electrode layer 120. Therefore, a composition of the common material influences characteristics of the dielectric layer.

The “common material” throughout the specification of the present invention is used together with the metal powders in the internal electrode layer, which means a material delaying a firing temperature of the metal powders.

The multilayered ceramic component according to a first exemplary embodiment of the present invention is characterized in that it has a structure in which the internal electrode layer and the dielectric layer are alternately multilayered, and the internal electrode layer includes 0.01 to 12 wt % of a common material based on the weight of the metal powders, and an average particle size of the common material is within 30% of an average particle size of the metal powders.

In the first exemplary embodiment, a content and a particle size of the common material included in order to delay the sintering of the internal electrode layer are controlled in a specific range with respect to the metal powders, thereby maximizing the connectivity of the internal electrode in the multilayered ceramic component.

The internal electrode layer according to the present invention includes the metal powder used as the internal electrode and the common material used as a sintering inhibitor. It is preferable that 0.01 to 12 wt % of the common material based on the weight of the metal powders is included. In the case in which the content of the common material is less than 0.01 wt % based on the metal powders, an effect improving electrode connectivity is insufficient. In the case in which the content of the common material is more than 12 wt %, at the time of sintering, the common material is squeezed out to the dielectric layer to thereby excessively increase a thickness of the dielectric layer, such that the capacity may be decreased, which is not preferable.

In addition, the average particle size of the common material is within 30% of an average particle size of the metal powders. In the case in which the average particle size of the common material is 30% or more the average particle size of the metal powders, with the added small amount, the sintering shrinkage operation in the internal electrode is not controlled to thereby deteriorate the reliability, which is not preferable.

The common material uses the same component as the barium titanate configuring the dielectric layer. Therefore, it is general that the common material moves to the internal electrode layer at a temperature in which a shrinkage starting temperature of the metal powders becomes a high temperature as high as possible, and is absorbed into the dielectric layer at the process in which the internal electrode is fired.

However, in the case in which the average particle size and the content of the common material are controlled as described above, the fine common materials are trapped to a fine pore between the metal powders used as the internal electrode, and is not squeezed out to the dielectric layer according to a sintering condition to be trapped in the internal electrode layer. The trapped common material finally controls the high temperature contradiction operation in the internal electrode, resulting in forming an electrode having high connectivity.

In the common material according to the exemplary embodiments of the present invention, barium titanate (BaTiO₃), which is the same material as the dielectric layer, is used as a main component, and mixed with the metal oxide as a minor component. The metal of the metal oxide may be at least one lanthanide rare-earth element selected from a group consisting of Y³⁺, La³⁺, Ce³⁺, Pr³⁺, Nd³⁺, Sm³⁺, Eu³⁺, Gd³⁺, Tb³⁺, Dy³⁺, Ho³⁺, Er³⁺, Tm³⁺, Yb³⁺ and Lu³⁺.

Preferably, nickel (Ni) or copper (Cu) may be used for the metal powder of the internal electrode layer, and the internal electrode layer have a thickness of 0.1 to 0.5 μm. In the case in which the thickness of the internal electrode layer is more than 0.5 μm, the layered number of chips in the same MLCC are decreased, such that it is not preferable in order to implement capacity characteristics.

In addition, the multilayered ceramic component according to a second exemplary embodiment of the present invention is characterized in that it has a structure in which the internal electrode layer and the dielectric layer are alternately multilayered, the internal electrode layer includes 0.01 to 12 wt % of a common material based on the weight of the metal powders, an average particle size of the common material is within 30% of an average particle size of the metal powders, and after sintering, the content ratio of the common material remaining in the internal electrode layer to the total common material content is 0.006˜0.1.

According to the second exemplary embodiment of the present invention, it is characterized in that the common material is partially squeezed out to the dielectric layer by controlling the content and the particle size of the common material, and the rest of the common material is trapped to be remained in the internal electrode layer, thereby improving the connectivity of the internal electrode.

Specifically, it is preferable that the content ratio of the common material remaining in the internal electrode layer to the total common material content is in the range of 0.006˜0.1. In the case in which the content ratio is less than 0.006, it is difficult to implement reliability and capacity characteristics due to the reduction in electrode connectivity. In addition, in the case in which the content ratio is more than 0.1, the electrode having an excessive thickness is formed, resulting in increasing the thickness of the MLCC chip, which is not preferable.

Controlling the content of the common material remaining in the internal electrode layer in the range as described above may be achieved by controlling the particle size and the content of the common material to be used. Therefore, it is preferable that the internal electrode layer according to the second exemplary embodiment of the present invention includes 0.01 to 12 wt % of a common material based on the weight of the metal powders, and an average particle size of the common material is within 30% of an average particle size of the metal powders.

In the common material according to the second exemplary embodiment of the present invention, barium titanate (BaTiO₃) which is the same material as the dielectric layer is used as a main component, and mixed with the metal oxide as a minor component. The metal of the metal oxide may be at least one lanthanide rare-earth element selected from a group consisting of Y³⁺, La³⁺, Ce³⁺, Pr³⁺, Nd³⁺, Sm³⁺, Eu³⁺, Gd³⁺, Tb³⁺, Dy³⁺, Ho³⁺, Er³⁺, Tm³⁺, Yb³⁺ and Lu³⁺.

Preferably, nickel (Ni) or copper (Cu) may be used for the metal powder of the internal electrode layer, and the internal electrode layer have a thickness of 0.1 to 0.5 μm. In the case in which the thickness of the internal electrode layer is more than 0.5 μm, the layered numbers of the chip in the same MLCC are decreased, such that it is not preferable to implement the capacity characteristics.

In addition, it is characterized in that the multilayered ceramic component according to the third exemplary embodiment of the present invention has a structure in which the internal electrode layers and the dielectric layer are alternately multilayered, the internal electrode layers include 0.01 to 12 wt % of common material based on the weight of the metal powders, the average particle size of the common material is within 30% of an average particle size of the metal powders, and after sintering, the content ratio of the common material remaining in the internal electrode layer to the total common material content is 0.006˜0.1, and in the common material remaining in the internal electrode layer, when it is assumed that a fraction of the common material remaining in upper and lower regions in +20% from the center of the internal electrode layer is A(center) and the fraction of the common material remaining in a region of the internal electrode layer other than the region is A(interface), A(center)/A(interface) is 10 to 2.

According to the third exemplary embodiment of the present invention, it is characterized that the average particle size and the content of the common material are controlled, such that the common material remains while being trapped in a predetermined content in the internal electrode layer; however, the common material remaining in the internal electrode layer is controlled so as to be distributed in the center in a relatively larger amount, as compared to both sides of the internal electrode layer.

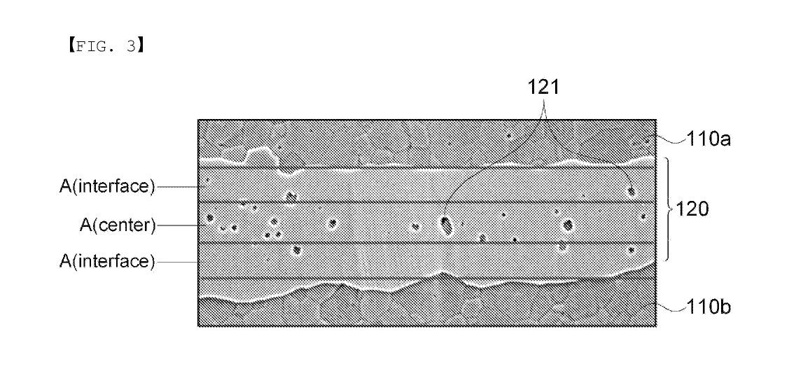

That is, as shown in FIG. 2, it is characterized in that the multilayered ceramic component has a structure in which the dielectric layer 110a and 110b and the internal electrode layer 120 are multilayered, the internal electrode layer 120 includes 12 wt % or less of a common material based on the weight of the metal powders, and an average particle size of the common material is within 30% of an average particle size of the metal powders.

In addition, after sintering, the content ratio of the common material 121 remaining in the internal electrode layer 120 to the total common material content is 0.006˜0.1, and in the common material 121 remaining in the internal electrode layer 120, when it is assumed that a fraction of the common material remaining in upper and lower regions in +20% from the center of the internal electrode layer is A(center) and the fraction of the common material remaining in a region of the internal electrode layer other than the region is A(interface), A(center)/A(interface) is 10 to 2.

In the case in which the A(center)/A(interface) is within the range, the common materials are properly trapped in the center of the internal electrode layer, thereby making it possible to improve the connectivity of the internal electrode as much as possible.

In the common material according to the third exemplary embodiment of the present invention, barium titanate (BaTiO₃) which is the same material as the dielectric layer is used as a main component, and mixed with the metal oxide as a minor component. The metal of the metal oxide may be at least one lanthanide rare-earth element selected from a group consisting of Y³⁺, La³⁺, Ce³⁺, Pr³⁺, Nd³⁺, Sm³⁺, Eu³⁺, Gd³⁺, Tb³⁺, Dy³⁺, Ho³⁺, Er³⁺, Tm³⁺, Yb³⁺ and Lu³⁺.

Preferably, nickel (Ni) or copper (Cu) may be used for the metal powder of the internal electrode layer, and the internal electrode layer have a thickness of 0.1 to 0.5 μm. In the case in which the thickness of the internal electrode layer is more than 0.5 μm, the layered numbers of chips in the same MLCC are decreased, such that it is not preferable in order to implement capacity characteristics.

Hereinafter, the exemplary embodiments of the present invention will be described in detail. The following examples are only for illustrating the present invention, and the scope of the present specification and claims should not be construed as being limited by these examples. In addition, specific compounds are used in the following examples, but it is obvious to those skilled in the art that equivalents thereof can exhibit the same or similar degrees of effects.

### Example and Comparative Example

Each multilayered electronic component (MLCC) was prepared by changing the compositional ratio, particle sizes, and contents of respective components as shown in FIG. 1. A nickel metal was used for metal powders of internal electrode layers, and barium titanium as a main component and a metal oxide as a minor component were included for a common material, thereby manufacturing a super high capacity MLCC (the dielectric layer having a thickness of 0.5 μm or less, and the internal electrode having a thickness of 0.3 μm.

In addition, for capacity of the manufactured super high capacity MLCC, breakdown voltage accelerated life span was measured, electrode connectivity was measured by an optical microscope and image analysis, and the measurement results were shown in Table 1 below.

TABLE 1

| | | | Content Ratio of | | | |
|---|---|---|---|---|---|---|
| | | Added | Common Material | | | |
| | | Amount of | Remaining in | | | |
| | D(Common | Common | Internal Electrode | | | |
| Sample | Material)/ | Material | Layer to Total | A(Center)/ | Electrode | |
| No. | D(Nickel) | (wt %/Ni) | Common Material | A(Interface) | Connectivity | Capacity |
| 1 | 0.2~0.3 | 1 | 0.006 | 9.792 | ◯ | ◯ |
| 2 | 0.2~0.3 | 2 | 0.006 | 9.125 | ◯ | ◯ |
| 3 | 0.2~0.3 | 3 | 0.006 | 9.342 | ◯ | ◯ |
| 4 | 0.2~0.3 | 4 | 0.006 | 8.912 | ◯ | ◯ |
| 5 | 0.2~0.3 | 6 | 0.007 | 8.784 | ◯ | ◯ |
| 6 | 0.2~0.3 | 8 | 0.008 | 8.552 | ◯ | ⊚ |
| 7 | 0.2~0.3 | 10 | 0.012 | 8.648 | ⊚ | ⊚ |
| 8 | 0.2~0.3 | 12 | 0.015 | 8.157 | ⊚ | ◯ |
| 9* | 0.2~0.3 | 14 | 0.017 | 8.465 | ⊚ | X |
| 10* | 0.2~0.3 | 20 | 0.025 | 8.843 | ⊚ | X |
| 11 | 0.15~0.2 | 1 | 0.008 | 5.112 | ◯ | ◯ |
| 12 | 0.15~0.2 | 2 | 0.014 | 5.134 | ◯ | ◯ |
| 13 | 0.15~0.2 | 3 | 0.020 | 4.992 | ◯ | ⊚ |
| 14 | 0.15~0.2 | 4 | 0.027 | 4.984 | ◯ | ⊚ |
| 15 | 0.15~0.2 | 6 | 0.039 | 5.047 | ⊚ | ⊚ |
| 16 | 0.15~0.2 | 8 | 0.046 | 4.946 | ⊚ | ◯ |
| 17 | 0.15~0.2 | 10 | 0.050 | 4.845 | ⊚ | ◯ |
| 18 | 0.15~0.2 | 12 | 0.058 | 4.778 | ⊚ | ◯ |
| 19* | 0.15~0.2 | 14 | 0.061 | 4.512 | ⊚ | X |
| 20* | 0.15~0.2 | 20 | 0.078 | 4.912 | ⊚ | X |
| 21 | 0.1~0.15 | 1 | 0.009 | 2.549 | ◯ | ◯ |
| 22 | 0.1~0.15 | 2 | 0.017 | 2.138 | ◯ | ⊚ |
| 23 | 0.1~0.15 | 3 | 0.025 | 2.266 | ⊚ | ⊚ |
| 24 | 0.1~0.15 | 4 | 0.031 | 2.349 | ⊚ | ⊚ |
| 25 | 0.1~0.15 | 6 | 0.049 | 2.465 | ⊚ | ⊚ |
| 26 | 0.1~0.15 | 8 | 0.061 | 2.731 | ⊚ | ⊚ |
| 27 | 0.1~0.15 | 10 | 0.070 | 2.659 | ⊚ | ⊚ |
| 28 | 0.1~0.15 | 12 | 0.081 | 2.228 | ⊚ | ◯ |
| 29* | 0.1~0.15 | 14 | 0.089 | 2.648 | ⊚ | X |
| 30* | 0.1~0.15 | 20 | 0.098 | 2.167 | ⊚ | X |

Note 1) * is out of the range of the present invention
Note 2) X: defective (less than 75%), ◯: good (75~85%), ⊚: very good (more than 85%)

It could be appreciated from Table 1 above that in the case in which the common material used in the internal electrode layer is contained in 0.01 to 12 wt % based on the weight of the metal powder, and the average particle size of the common material is within 30% of an average particle size of the metal powder, the fine common material is effectively trapped in the internal electrode layer, such that high temperature sintering shrinkage is easily controlled, thereby improving the connectivity of the internal electrode.

In addition, it could be appreciated that the content of the common material trapped and remaining in the internal electrode layer is increased as the content of the common material to be added is increased.

In addition, the content of the common material trapped in the center A(center) of the internal electrode layer and the content of the common material trapped in the region A(interface) other than the center could be controlled by controlling the fraction of average particle between the nickel used as the metal powder and the common material.

Further, as shown in FIG. 3, it could be appreciated that the fine common materials were largely trapped and remained in the center of the internal electrode layer, as the result of measuring the dielectric layer having super high capacity MLCC manufactured according to the present invention using FE-SEM. From the above results of the present invention, it could be appreciated that the fine common materials are trapped between the nickel powders of the internal electrode, and as the fraction of the trapped common material is increased, the connectivity of the internal electrode is improved.

As set forth above, according to the first exemplary embodiment of the present invention, the particle size and the added amount of common material squeezed out from the internal electrode layer at the time of firing at a high temperature are controlled, thereby making it possible to improve the connectivity of the internal electrode.

In addition, according to the second exemplary embodiment of the present invention, the particle size and the added amount of the common material included in the internal electrode layer are controlled to allow a predetermined content of the common material to be trapped so as not to be squeezed out from the internal electrode layer after sintering, such that the high temperature shrinkage operation is controlled in the internal electrode, thereby making it possible to improve electrode connectivity of the internal electrode layer.

Further, according to the third exemplary embodiment of the present invention, after the particle size and the added amount of the common material included in the internal electrode layer are controlled and the sintering process is performed, a predetermined content of the common material is trapped so as not to be squeezed out from the internal electrode layer and the content of the common material trapped in the center of the internal electrode layer is controlled to be larger than that of the common material trapped in the interface between the internal electrode layer and the dielectric layer and the high temperature shrinkage operation is controlled in the internal electrode, thereby making it possible to improve electrode connectivity of the internal electrode layer.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A multilayered ceramic component having a structure in which internal electrode layers and dielectric layers are alternately multilayered,
wherein the internal electrode layer includes 0.01 to 12 wt % of common material based on weight of metal powders, and an average particle size of the common material is within 30% of an average particle size of the metal powders.

2. A multilayered ceramic component having a structure in which internal electrode layers and dielectric layers are alternately multilayered,
wherein the internal electrode layer includes 0.01 to 12 wt % of common material based on weight of metal powders, an average particle size of the common material is within 30% of an average particle size of the metal powders, and
a content ratio of the common material remaining in the internal electrode layer to the total common material content, after sintering, is 0.006˜0.1.

3. A multilayered ceramic component having a structure in which internal electrode layers and dielectric layers are alternately multilayered,
wherein the internal electrode layer includes 0.01 to 12 wt % of common material based on weight of metal powders, and an average particle size of the common material is within 30% of an average particle size of the metal powders,
a content ratio of the common material remaining in the internal electrode layer to the total common material content, after sintering, is 0.006˜0.1, and
when it is assumed that a fraction of the common material remaining in upper and lower regions in +20% from the center of the internal electrode layer is A(center) and the fraction of the common material remaining in a region of the internal electrode layer other than the region is A(interface), A(center)/A(interface) is 10 to 2.

4. The multilayered ceramic component according to any one of claims 1 to 3, wherein the internal electrode layer has a thickness of 0.1 to 0.5 μm.

5. The multilayered ceramic component according to any one of claims 1 to 3, wherein the internal electrode layer is made of nickel (Ni) or copper (Cu).

6. The multilayered ceramic component according to any one of claims 1 to 3, wherein the common material includes barium titanate (BaTiO₃) and a metal oxide.

7. The multilayered ceramic component according to claim 6, wherein a metal of the metal oxide is at least one lanthanide rare-earth element selected from a group consisting of Y³⁺, La³⁺, Ce³⁺, Pr³⁺, Nd³⁺, Sm³⁺, Eu³⁺, Gd³⁺, Tb³⁺, Dy³⁺, Ho³⁺, Er³⁺, Tm³⁺, Yb³⁺ and Lu³⁺.
